(19) United States
(12) Patent Application Publication
(10) Pub. No.: US 2023/0186562 A1
(43) Pub. Date: Jun. 15, 2023

(54) METHOD AND SYSTEM FOR 3D MODELING BASED ON VOLUME ESTIMATION

(71) Applicant: RECON LABS INC., Seoul (KR)

(72) Inventors: Kyungwon YUN, Seoul (KR); Sergio Bromberg Dimate, Seoul (KR); Leonard YOON, Suwon-si (KR); Seonghoon BAN, Seoul (KR)

(73) Assignee: RECON LABS INC., Seoul (KR)

(21) Appl. No.: 17/583,335

(22) Filed: Jan. 25, 2022

(30) Foreign Application Priority Data
Dec. 15, 2021 (KR) 10-2021-0180168

(51) Int. Cl. G06T 17/20; G06T 7/62; G06T 7/70

(52) U.S. Cl. CPC G06T 17/20; G06T 7/62; G06T 7/70; G06T 2207/20081

(57) ABSTRACT

The present disclosure relates to a method for 3D modeling based on volume estimation, in which the method is executed by one or more processors, and includes receiving a plurality of images obtained by capturing an image of a target object positioned in a specific space from different directions, estimating a position and pose at which each image is captured, training a volume estimation model based on the plurality of images and the position and pose at which each image is captured, and generating a 3D model of the target object by using the volume estimation model.

### CROSS-REFERENCE TO RELATED APPLICATION

This application claims priority to Korean Patent Application No. 10-2021-0180168, filed in the Korean Intellectual Property Office on Dec. 15, 2021, the entire contents of which are hereby incorporated by reference.

### TECHNICAL FIELD

The present disclosure relates to a method and a system for 3D modeling based on volume estimation, and specifically, to a method and a system for training a volume estimation model based on a plurality of images obtained by capturing an image of a target object from different directions, and generating a 3D model of the target object by using the trained volume estimation model.

### BACKGROUND

In the related art, to produce a 3D model of an object, a 3D modeling work is generally performed using a program such as CAD. Since a certain level of skill is required to perform these work, most of the 3D modeling work was performed by experts. Accordingly, there is a problem that the 3D modeling work is time and cost consuming, and the quality of the produced 3D model varies greatly according to the operator.

Recently, a technology for automating 3D modeling based on photographies or images of a target object captured from various angles has been introduced, making it possible to produce a 3D model within a short time. While general techniques for automating general 3D modeling involve the process of extracting feature points from the image, this method has a problem in that, depending on the features of the object, the feature points are not properly extracted, or a 3D model is generated, which does not faithfully reflect the shape of the object.

### SUMMARY

In order to solve the problems described above, the present disclosure provides a method for, a non-transitory computer-readable recording medium storing instructions for, and an apparatus (system) for 3D modeling based on volume estimation.

The present disclosure may be implemented in a variety of ways, including a method, an apparatus (system), or a non-transitory computer-readable storage medium storing instructions.

According to an embodiment, a method for 3D modeling based on volume estimation is provided, which may be executed by one or more processors and include receiving a plurality of images obtained by capturing an image of a target object positioned in a specific space from different directions, estimating a position and pose at which each image is captured, training a volume estimation model based on the plurality of images and the position and pose at which each image is captured, and generating a 3D model of the target object by using the volume estimation model.

According to an embodiment, the volume estimation model may be a model trained to receive position information and viewing direction information on the specific space and output color values and volume density values.

According to an embodiment, the volume estimation model may be trained to minimize a difference between the pixel value included in a plurality of images and the estimated pixel value calculated based on the color value and volume density value estimated by the volume estimation model.

According to an embodiment, the generating the 3D model of the target object may include generating a 3D depth map of the target object by using the volume estimation model, generating a 3D mesh of the target object based on the generated 3D depth map, and applying texture information on the 3D mesh to generate the 3D model of the target object.

According to an embodiment, the 3D depth map of the target object may be generated based on the volume density values at a plurality of points on the specific space inferred by the volume estimation model.

According to an embodiment, the texture information may be determined based on the color values at a plurality of points and plurality of viewing directions on the specific space inferred by the volume estimation model.

According to an embodiment, it may further include estimating a camera model based on a plurality of images, transforming the plurality of images into a plurality of undistorted images by using the estimated camera model, in which the volume estimation model is a model trained by using the plurality of undistorted images.

According to an embodiment, the generating the 3D model of the target object may include generating a 3D depth map of the target object by using the volume estimation model, transforming the 3D depth map by using the camera model, generating a 3D mesh of the target object based on the transformed 3D depth map, and applying texture information on the 3D mesh to generate the 3D model of the target object.

There is provided a non-transitory computer-readable recording medium storing instructions for executing, on a computer, the method for 3D modeling based on volume estimation according to the embodiment of the present disclosure.

According to an embodiment, an information processing system is provided, which may include a communication module, a memory, and one or more processors connected to the memory and configured to execute one or more computer-readable programs included in the memory, in which the one or more programs may include instructions for receiving a plurality of images obtained by capturing an image of a target object positioned in a specific space from different directions, estimating a position and pose at which each image is captured, training a volume estimation model based on the plurality of images and the position and pose at which each image is captured, and generating a 3D model of the target object by using the volume estimation model.

According to some embodiments of the present disclosure, by training a volume estimation model and using the trained volume estimation model to generate a 3D model, it is possible to generate a high-quality 3D model that implements the shape and/or texture of the target object accurately and precisely.

According to some embodiments of the present disclosure, since it is possible to estimate color values and volume density values for all positions and viewing directions within a specific space where the target object is positioned, a high-resolution, precise and accurate depth map can be generated, and a high-quality 3D model can be generated based on the same.

According to some embodiments of the present disclosure, by performing a process of transforming an image into an undistorted image in the process of generating the 3D depth map, a precise and accurate 3D depth map can be generated.

According to some embodiments of the present disclosure, in the process of generating a 3D model based on the 3D depth map, by performing the process of inversely transforming the 3D depth map, it is possible to implement a realistic 3D model that makes the user viewing a 3D model through a user terminal feel as if he or she is capturing a real object with a camera.

The effects of the present disclosure are not limited to the effects described above, and other effects not described herein can be clearly understood by those of ordinary skill in the art (referred to as “ordinary technician”) from the description of the claims.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram illustrating an example in which a user captures images of a target object from various directions using a user terminal and generates a 3D model according to an embodiment;

FIG. 2 is a block diagram illustrating an internal configuration of a user terminal and an information processing system according to an embodiment;

FIG. 3 is a diagram illustrating an example of a method for 3D modeling based on volume estimation according to an embodiment;

FIG. 4 is a diagram illustrating an example of a method for training a volume estimation model according to an embodiment;

FIG. 5 is a diagram illustrating an example of comparing a 3D model generated by a 3D modeling method according to an embodiment and a 3D model generated by a related method;

FIG. 6 is a diagram illustrating an example of a method for 3D modeling based on volume estimation in consideration of camera distortion according to an embodiment;

FIG. 7 is a diagram illustrating an example of comparing a distorted image and an undistorted image according to an embodiment; and

FIG. 8 is a flowchart illustrating an example of a method for 3D modeling based on volume estimation according to an embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding components are assigned the same reference numerals. In addition, in the following description of the embodiments, duplicate descriptions of the same or corresponding components may be omitted. However, even if descriptions of components are omitted, it is not intended that such components are not included in any embodiment.

Advantages and features of the disclosed embodiments and methods of accomplishing the same will be apparent by referring to embodiments described below in connection with the accompanying drawings. However, the present disclosure is not limited to the embodiments disclosed below, and may be implemented in various forms different from each other, and the present embodiments are merely provided to make the present disclosure complete, and to fully disclose the scope of the invention to those skilled in the art to which the present disclosure pertains.

The terms used herein will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in specific cases, certain terms may be arbitrarily selected by the applicant, and the meaning of the terms will be described in detail in a corresponding description of the embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to reproduce one or more processors. Accordingly, as an example, the “module” or “unit” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an embodiment, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination of processing devices, e.g., a combination of a DSP and a microprocessor, a plurality of microprocessors, one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, “system” may refer to at least one of a server device and a cloud device, but not limited thereto. For example, the system may include one or more server devices. In another example, the system may include one or more cloud devices. In still another example, the system may include both the server device and the cloud device operated in conjunction with each other.

In the present disclosure, the “machine learning model” may include any model that is used for inferring an answer to a given input. According to an embodiment, the machine learning model may include an artificial neural network model including an input layer, a plurality of hidden layers, and an output layer, where each layer may include a plurality of nodes. In the present disclosure, the machine learning model may refer to an artificial neural network model, and the artificial neural network model may refer to the machine learning model. In the present disclosure, “volume estimation model” may be implemented as a machine learning model. In some embodiments of the present disclosure, a model described as one machine learning model may include a plurality of machine learning models, and a plurality of models described as separate machine learning models may be implemented into a single machine learning model.

In the present disclosure, “display” may refer to any display device associated with a computing device, and for example, it may refer to any display device that is controlled by the computing device, or that can display any information/data provided from the computing device.

In the present disclosure, “each of a plurality of A” may refer to each of all components included in the plurality of A, or may refer to each of some of the components included in a plurality of A.

In some embodiments of the present disclosure, “a plurality of images” may refer to an image including a plurality of images, and an “image” may refer to a plurality of images included in the image.

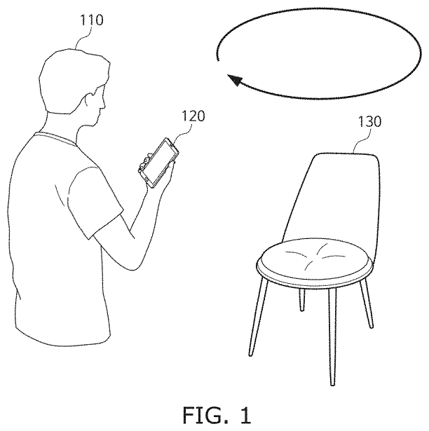

FIG. 1 is a diagram illustrating an example in which a user 110 captures an image of a target object 130 from various directions using a user terminal 120 and generates a 3D model according to an embodiment. According to an embodiment, the user 110 may use a camera (or an image sensor) provided in the user terminal 120 to capture an image of the object 130 (hereinafter referred to as “target object”) as a target of 3D modeling from various directions, and request to generate a 3D model. For example, the user 110 may capture an image including the target object 130 while rotating around the target object 130, using a camera provided in the user terminal 120. Then, the user 110 may request 3D modeling using the captured image (or a plurality of images included in the image) through the user terminal 120. According to another embodiment, the user 110 may select an image stored in the user terminal 120 or an image stored in another system accessible from the user terminal 120, and then request 3D modeling using the corresponding image (or a plurality of images included in the image). When 3D modeling is requested by the user 110, the user terminal 120 may transmit the captured image or the selected image to the information processing system.

The information processing system may receive the image (or a plurality of images included in the image) of the target object 130, and estimate a position and pose at which each of the plurality of images in the image is captured. The position and pose at which each image is captured may refer to a position and direction of the camera at a time point of capturing each image. Then, the information processing system may train a volume estimation model based on the plurality of images and the position and pose at which each image is captured, and generate a 3D model of the target object 130 by using the trained volume estimation model.

In the description provided above, the process of generating a 3D model using a plurality of images has been described as being performed by the information processing system, but embodiments are not limited thereto and it may be implemented differently in other embodiments. For example, at least some or all of a series of processes for generating a 3D model using a plurality of images may be performed by the user terminal 120. However, for convenience of explanation, the following description will be made on the premise that the 3D model generation process is performed by the information processing system.

According to the method for 3D modeling based on volume of the present disclosure, instead of extracting feature points from an image and generating a 3D model based on this, the method may train a volume estimation model and use the trained volume estimation model to generate a 3D model, thereby implementing the shape and/or texture of the target object 130 accurately and precisely.

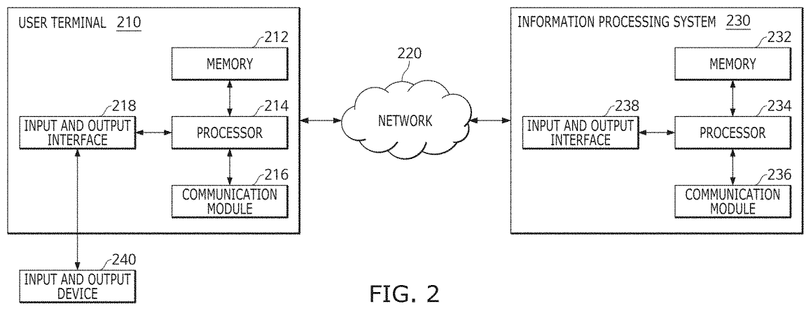

FIG. 2 is a block diagram illustrating an internal configuration of a user terminal 210 and an information processing system 230 according to an embodiment. The user terminal 210 may refer to any computing device that is capable of executing a 3D modeling application, a web browser, and the like and capable of wired/wireless communication, and may include a mobile phone terminal, a tablet terminal, a PC terminal, and the like, for example. As illustrated, the user terminal 210 may include a memory 212, a processor 214, a communication module 216, and an input and output interface 218. Likewise, the information processing system 230 may include a memory 232, a processor 234, a communication module 236, and an input and output interface 238. As illustrated in FIG. 2, the user terminal 210 and the information processing system 230 may be configured to communicate information and/or data through a network 220 using the respective communication modules 216 and 236. In addition, an input and output device 240 may be configured to input information and/or data to the user terminal 210 or to output information and/or data generated from the user terminal 210 through the input and output interface 218.

The memories 212 and 232 may include any non-transitory computer-readable recording medium. According to an embodiment, the memories 212 and 232 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 210 or the information processing system 230 as a separate permanent storage device that is distinct from the memory. In addition, an operating system and at least one program code (e.g., a code for a 3D modeling application, and the like installed and driven in the user terminal 210) may be stored in the memories 212 and 232.

These software components may be loaded from a computer-readable recording medium separate from the memories 212 and 232. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, and so on, for example. As another example, the software components may be loaded into the memories 212 and 232 through the communication modules rather than the computer-readable recording medium. For example, at least one program may be loaded into the memories 212 and 232 based on a computer program installed by files provided by developers or a file distribution system that distributes an installation file of an application through the network 220.

The processors 214 and 234 may be configured to process the instructions of the computer program by performing basic arithmetic, logic, and input and output operations. The instructions may be provided to the processors 214 and 234 from the memories 212 and 232 or the communication modules 216 and 236. For example, the processors 214 and 234 may be configured to execute the received instructions according to program code stored in a recording device such as the memories 212 and 232.

The communication modules 216 and 236 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system or the like). For example, a request or data (e.g., a request to generate a 3D model, a plurality of images or an image of the target object captured from various directions, and the like) generated by the processor 214 of the user terminal 210 according to the program code stored in the recording device such as the memory 212 or the like may be transmitted to the information processing system 230 through the network 220 under the control of the communication module 216. Conversely, a control signal or a command provided under the control of the processor 234 of the information processing system 230 may be received by the user terminal 210 through the communication module 216 of the user terminal 210 via the communication module 236 and the network 220. For example, the user terminal 210 may receive 3D model data of the target object from the information processing system 230 through the communication module 216.

The input and output interface 218 may be a means for interfacing with the input and output device 240. As an example, the input device may include a device such as a camera including an audio sensor and/or an image sensor, a keyboard, a microphone, a mouse, and so on, and the output device may include a device such as a display, a speaker, a haptic feedback device, and so on. As another example, the input and output interface 218 may be a means for interfacing with a device such as a touch screen or the like that integrates a configuration or function for performing inputting and outputting. For example, when the processor 214 of the user terminal 210 processes the instructions of the computer program loaded in the memory 212, a service screen or the like, which is configured with the information and/or data provided by the information processing system 230 or other user terminals, may be displayed on the display through the input and output interface 218. While FIG. 2 illustrates that the input and output device 240 is not included in the user terminal 210, embodiments are not limited thereto, and the input and output device 240 may be configured as one device with the user terminal 210. In addition, the input and output interface 238 of the information processing system 230 may be a means for interfacing with a device (not illustrated) for inputting or outputting that may be connected to, or included in the information processing system 230. In FIG. 2, while the input and output interfaces 218 and 238 are illustrated as the components configured separately from the processors 214 and 234, embodiments are not limited thereto, and the input and output interfaces 218 and 238 may be configured to be included in the processors 214 and 234.

The user terminal 210 and the information processing system 230 may include more than those components illustrated in FIG. 2. Meanwhile, most of the related components may not necessarily require exact illustration. According to an embodiment, the user terminal 210 may be implemented to include at least a part of the input and output device 240 described above. In addition, the user terminal 210 may further include other components such as a transceiver, a Global Positioning System (GPS) module, a camera, various sensors, a database, and the like. For example, when the user terminal 210 is a smartphone, it may include components generally included in the smartphone. For example, in an implementation, various components such as an acceleration sensor, a gyro sensor, a camera module, various physical buttons, buttons using a touch panel, input and output ports, a vibrator for vibration, and so on may be further included in the user terminal 210. According to an embodiment, the processor 214 of the user terminal 210 may be configured to operate an application or the like that provides a 3D model generation service. In this case, a code associated with the application and/or program may be loaded into the memory 212 of the user terminal 210.

While the program for the application or the like that provides the 3D model generation service is being operated, the processor 214 may receive text, image, video, audio, and/or action, and so on inputted or selected through the input device such as a camera, a microphone, and so on, that includes a touch screen, a keyboard, an audio sensor and/or an image sensor connected to the input and output interface 218, and store the received text, image, video, audio, and/or action, and so on in the memory 212, or provide the same to the information processing system 230 through the communication module 216 and the network 220. For example, the processor 214 may receive a plurality of images or an image of the target object captured through a camera connected to the input and output interface 218, receive a user input requesting generation of a 3D model of the target object, and provide the plurality of images or image to the information processing system 230 through the communication module 216 and the network 220. As another example, the processor 214 may receive an input indicating a user's selection made with respect to the plurality of images or image, and provide the selected plurality of images or image to the information processing system 230 through the communication module 216 and the network 220.

The processor 214 of the user terminal 210 may be configured to manage, process, and/or store the information and/or data received from the input device 240, another user terminal, the information processing system 230 and/or a plurality of external systems. The information and/or data processed by the processor 214 may be provided to the information processing system 230 through the communication module 216 and the network 220. The processor 214 of the user terminal 210 may transmit the information and/or data to the input and output device 240 through the input and output interface 218 to output the same. For example, the processor 214 may display the received information and/or data on a screen of the user terminal.

The processor 234 of the information processing system 230 may be configured to manage, process, and/or store information and/or data received from a plurality of user terminals 210 and/or a plurality of external systems. The information and/or data processed by the processor 234 may be provided to the user terminals 210 through the communication module 236 and the network 220. For example, the processor 234 of the information processing system 230 may receive a plurality of images from the user terminal 210, and estimate the position and pose at which each image is captured, and then train the volume estimation model based on the plurality of images and the position and pose at which each image is captured, and generate a 3D model of the target object by using the trained volume estimation model. The processor 234 of the information processing system 230 may provide the generated 3D model to the user terminal 210 through the communication module 236 and the network 220.

The processor 234 of the information processing system 230 may be configured to output the processed information and/or data through the input and output device 240 such as a device (e.g., a touch screen, a display, and so on) capable of outputting a display of the user terminal 210 or a device (e.g., a speaker) capable of outputting an audio. For example, the processor 234 of the information processing system 230 may be configured to provide the 3D model of the target object to the user terminal 210 through the communication module 236 and the network 220 and output the 3D model through a device capable of outputting a display, or the like of the user terminal 210.

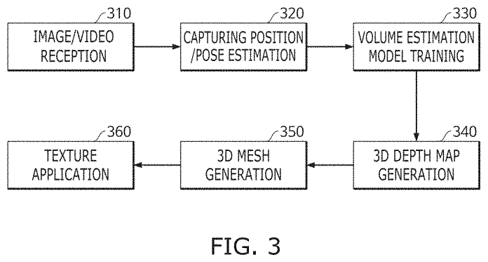

FIG. 3 is a diagram illustrating an example of a method for 3D modeling based on volume estimation according to an embodiment. First, the information processing system may receive a plurality of images obtaining by capturing an image of a target object positioned in a specific space from different directions, or receive an image obtained by capturing an image of the target object from various directions, at 310. When the information processing system receives the image, the information processing system may acquire a plurality of images included in the image. For example, the information processing system may receive from the user terminal an image captured while rotating around the target object, and acquire a plurality of images from the image.

Then, the information processing system may estimate a position and pose at which each image is captured, at 320. In this case, the “position and pose at which each image is captured” may refer to the position and direction of the camera at the time point of capturing each image. In order to estimate the position and pose, various estimation methods for estimating the position and pose from the image may be used. For example, a photogrammetry technique of extracting feature points from a plurality of images and use the extracted feature points to estimate the position and pose at which each image is captured may be used, but embodiments are not limited thereto, and various methods for estimating a position and pose may be used.

Then, the information processing system may train the volume estimation model based on the plurality of images and the position and pose at which each image is captured, at 330. In this case, the volume estimation model may be a machine learning model (e.g., an artificial neural network model). According to an embodiment, the volume estimation model may be a model trained to receive position information and viewing direction information in a specific space and output color values and volume density values. For example, the volume estimation model may be expressed by the following equation.

F_{Θ}:(x,ϕ)→(c,σ) <Equation 1>

where, F is the volume estimation model, Θ is the parameter of the volume estimation model, x and ϕ are the position information and viewing direction in a specific space, respectively, and c and a are the color value and volume density value, respectively. As a specific example, the color value c may represent the color value (e.g., RGB color value) seen when viewed in the viewing direction ϕ with respect to the position x, and when viewed in the viewing direction ϕ with respect to position x, the volume density value σ may have a value of 0 when an object is not present, and may have any real value greater than 0 and less than or equal to 1 according to the transparency when an object is present (that is, the volume density may mean the rate that light is occluded). By using the trained volume estimation model, it is possible to estimate the color values and volume density values for any position and viewing direction in a specific space where the target object is positioned.

In an embodiment, the volume estimation model may be trained to minimize a difference between a pixel value included in a plurality of images and an estimated pixel value calculated based on the color value and volume density value estimated by the volume estimation model. That is, a loss function may be defined based on a difference between the pixel value included in the image and the estimated pixel value calculated based on the color value and the volume density value estimated by the volume estimation model. For example, the loss function for training the volume estimation model may be expressed by the following equation.

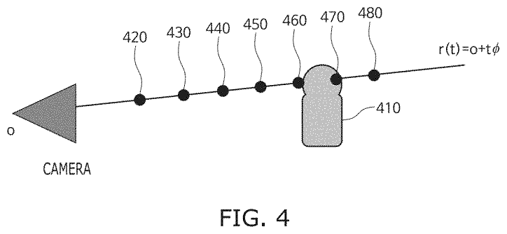

Loss=Σ∥Ĉ−C∥₂² <Equation 2>

where, C and Ĉ are a ground truth pixel value included in the image, and an estimated pixel value calculated based on the color value and volume density value estimated by the volume estimation model, respectively. A method for calculating the estimated pixel value Ĉ based on the color value and the volume density value estimated by the volume estimation model will be described in detail below with reference to FIG. 4.

After the training of the volume estimation model is completed, the information processing system may generate a 3D model of the target object by using the volume estimation model. In an embodiment, the color value and volume density value for any position and viewing direction in a specific space in which the target object is positioned can be estimated using the trained volume estimation model, and accordingly, a 3D model of the target object can be generated by using the same.

According to an embodiment, in order to generate a 3D model of the target object, the information processing system may first generate a 3D depth map of the target object by using the volume estimation model, at 340. For example, when viewing a specific space in which the target object is positioned at a specific position and specific pose, the distance to the nearest point having a non-zero volume density value may be estimated as the distance to the object. According to this method, the information processing system may generate a 3D depth map of the target object by using the volume estimation model.

Then, the information processing system may generate a 3D mesh of the target object based on the generated 3D depth map, at 350, and apply the texture information on the 3D mesh to generate a 3D model of the target object, at 360. According to an embodiment, the texture information herein may be determined based on the color values at a plurality of points and plurality of viewing directions in the specific space inferred by the volume estimation model.

According to the related 3D modeling method, since the 3D model is generated based on the feature points commonly extracted from a plurality of images, when the number of feature points that can be extracted from a plurality of images is small, a sparse depth map is generated, and even when a dense depth map is inferred from the sparse depth map, an incomplete depth map is generated due to loss of information. In contrast, by using the trained volume estimation model according to an embodiment, it is possible to estimate the color values and volume density values for all positions and viewing directions in the specific space in which the target object is positioned, and accordingly, it is possible to directly generate a dense depth map. That is, according to the present disclosure, it is possible to generate a high-resolution, precise and accurate depth map. In addition, it is possible to use the image super resolution technology to further enhance the resolution of the depth map. As described above, by generating the 3D model using the high-quality 3D depth map, it is possible to generate a high-quality 3D model close to the photorealistic quality.

FIG. 4 is a diagram illustrating an example of a method for training a volume estimation model according to an embodiment. According to an embodiment, the volume estimation model F may receive the position information x and viewing direction information ϕ in the specific space to infer the color value c and volume density value a. For example, the volume estimation model may be expressed by Equation 1 described above. In an embodiment, the volume estimation model may be trained to minimize the difference between the pixel value included in a plurality of images and the estimated pixel value calculated based on the color value and volume density value estimated by the volume estimation model. For example, the loss function for training the volume estimation model may be expressed by Equation 2 described above.

In Equation 2 described above, Ĉ denotes the estimated pixel value calculated based on the color value and volume density value estimated by the volume estimation model, in which the estimated pixel value may be calculated by the following process, for example.

First, the information processing system may assume a virtual ray (hereinafter, ray (optical path), r(t)=o+tϕ) connecting a point (one pixel) on the image plane from the focal center o of a plurality of images obtained by capturing an image of the target object 410. Then, a plurality of sampling points 420, 430, 440, 450, 460, 470, and 480 present along the ray may be extracted. For example, the information processing system may extract the plurality of sampling points 420, 430, 440, 450, 460, 470, and 480 at equal intervals on the ray. Then, the information processing system may input position information and viewing direction information (direction from the sampling point to the focal center) of the plurality of sampling points 420, 430, 440, 450, 460, 470, and 480 to the volume estimation model to infer the color values and volume density values of the corresponding points. Then, based on the color values and volume density values inferred for the plurality of sampling points 420, 430, 440, 450, 460, 470, and 480, estimated pixel values formed on the image plane (specifically, on the points where the corresponding ray meets the image plane, that is, on the pixels) may be calculated. For example, by calculating color values obtained by accumulating the color values inferred with respect to the plurality of sampling points 420, 430, 440, 450, 460, 470, and 480 in proportion to inferred volume density values, respectively, it is possible to calculate the estimated pixel values formed on the image plane. Specifically, the process of calculating the estimated pixel value based on the color value and volume density value estimated by the volume estimation model may be expressed by Equation 3 below.

Ĉ(r)=∫ₜ_{ₙ}^{t}^{_{f}}T(t)σ(r(t))c(r(t),ϕ)dt, where,T(t)=exp(−∫ₜ_{ₙ}^{t}σ(r(s))ds <Equation 3>

where r is the ray, Ĉ(r) is the estimated pixel value that is calculated, tₙ and t_{f} are a near boundary (that is, the nearest point with non-zero volume density), and a far boundary (that is, the furthest point with non-zero volume density), respectively, a is the volume density value, c is the color value, t and ϕ are the position information and viewing direction information of the sampling point, respectively, and T(t) is the cumulative transmittance from tₙ to t (that is, the probability that ray (light) can travel from tₙ to t without hitting any other particles). The process of calculating such estimated pixel values may be performed with respect to all pixels in the plurality of images.

The volume estimation model may be trained to minimize a difference between the estimated pixel values calculated based on the estimated color values and volume density values and the pixel values included in the real image. As a specific example, the loss function for training the volume estimation model may be expressed by Equation 4 below.

$$Loss = {\sum }_{r ∈ R} {‖ \hat{C} ( r ) - C ( r ) ‖}_{2}^{2} \qquad < Equation 4 >$$

where, r is a ray, R is a set of rays for a plurality of images, and C(r) and Ĉ(r) are the ground truth pixel value with respect to each ray r, and the estimated pixel values calculated based on the color values and volume density values estimated by the volume estimation model.

Additionally or alternatively, the information processing system may extract the plurality of sampling points 420, 430, 440, 450, 460, 470, and 480 present along the ray, and perform a process of calculating estimated pixel values a plurality of times. For example, the information processing system may perform a hierarchical volume sampling process. Specifically, instead of using one volume estimation model, it may use two models, i.e., a coarse model and a fine model. First, according to the method described above, color values and volume density values output from the coarse model may be inferred. Then, by using the output value of the coarse model, more sampling points may be extracted from a portion in which the target object (specifically, the surface of the target object, for example) is estimated to be present and fewer sampling points may be extracted from a portion in which the target object is estimated not to be present, to train a fine model. In this example, the loss function for training the fine model may be expressed by Equation 5 below.

$$Loss = {\sum }_{r ∈ R} [ {‖ {\hat{C}}_{c} ( r ) - C ( r ) ‖}_{2}^{2} + {‖ {\hat{C}}_{f} ( r ) - C ( r ) ‖}_{2}^{2} ] \qquad < Equation 5 >$$

where, R may denote a set of rays for a plurality of images, and C(r), Ĉ_{c} (r), and Ĉ_{f} (r) may denote a ground truth pixel value for ray r, an estimated color value based on the coarse model, and an estimated color value based on the fine model, respectively. Finally, a 3D model of the target object may be generated by using the trained fine model.

Additionally or alternatively, instead of estimating the volume density directly, it is possible to express the volume density on the ray with a signed distance function (SDF) to improve the accuracy of estimation of the surface position of the target object. For example, the volume density may be modeled as a variant of a learnable SDF. Specifically, the volume density may be modeled by Equation 6 below.

$$σ ( x ) = α {ψ}_{β} ( - {d}_{Ω} ( x ) ) \qquad < Equation 6 >$$

$$where , {1}_{Ω} ( x ) = \{ \begin{matrix}1 & if x ∈ Ω \\ 0 & if x ∉ Ω\end{matrix} , {d}_{Ω} ( x ) = {( - 1 )}^{{1}_{Ω} ( x )} {min}_{y ∈ ℳ} {‖ x - y ‖}_{2}$$

$${ψ}_{β} ( s ) = \{ \begin{matrix}\frac{1}{2} exp ( \frac{s}{β} ) , & if s \leq 0 \\ 1 - \frac{1}{2} exp ( - \frac{s}{β} ) , & if s > 0\end{matrix}$$

where, σ(x) is the volume density function, α,β are learnable parameters, ψ_{B} is the Cumulative Distribution Function (CDF) of the Laplace distribution with zero mean and a scale parameter of is the area occupied by the target object, [symbol] (=∂Ω) is the boundary surface of the target object, 1_{Ω} is a function that is 1 when the point x is within the area occupied by the target object, or 0 otherwise, d_{Ω} is a function of which value changes according to the distance to the boundary surface, while having a positive value when the point x is within the area occupied by the target object, or a negative value otherwise.

In this case, the loss function for training the volume estimation model may be defined based on the color loss and the Eikonal loss. In this case, the color loss may be calculated similarly to the method described above (e.g., Equation 2, Equation 4, or Equation 5), and the Eikonal loss is a loss representing a geometric penalty. Specifically, the loss function may be defined by Equation 7 below.

[symbol]

= [symbol] _{RGB}+λ [symbol] _{SDF} <Equation 7>

where, [symbol] is the total loss, [symbol] _{RGB} is the color loss, [symbol] _{SDF} is the Eikonal loss, and is a hyper-parameter (e.g., 0.1).

As described above, the information processing system may train the volume estimation model according to various methods, and generate a 3D model by using the trained volume estimation model.

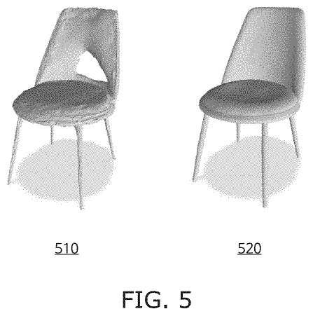

FIG. 5 is a diagram illustrating an example of comparing a 3D model 520 generated by a 3D modeling method according to an embodiment and a 3D model 510 generated by a related method. According to the related 3D modeling method, the feature points may be extracted from the image obtained by capturing an image of a target object, and the position values of the feature points in a 3D space may be estimated. In this case, the feature point may mean a point that can be estimated as the same point in a plurality of images. Then, a depth map for the 3D shape, or a point cloud may be generated based on the position values of the estimated feature points and a 3D mesh for the target object may be generated based on the depth map or the point cloud.

However, when the 3D model is generated according to the related method, the shape of the object may not be properly reflected depending on the features of the target object. For example, in the case of an object (e.g., solid-colored plastic, metal, and the like) having a texture for which it is difficult to specify the feature points, considerably fewer feature points are extracted and the shape of the object may not be properly reflected in the 3D model. As another example, in the case of an object having a reflective or transparent material, the feature point may be extracted from a different position from the real object due to reflection or refraction of light, or the feature points may be extracted from several different points but these points are actually the same point in the real object, in which case a 3D model with an abnormal shape and texture may be generated. As another example, when a thin and fine portion is included in the object, the feature points with a sufficiently large area to specify a surface are not distributed in the corresponding portion, and the portion may be recognized as a point rather than surface and omitted in the step of generating the 3D mesh. As described above, according to the related method, the 3D model may not be properly generated depending on the features of the target object.

An example of the 3D model 510 generated by the related method is illustrated in FIG. 5. As illustrated, since the 3D model 510 generated by the related method does not accurately reflect the surface position of the real target object, there is a problem in that the surface is not smooth and some portions are omitted.

In contrast, according to the 3D modeling method according to an embodiment, the volume estimation model is used instead of extracting the feature points from the image, and as a result, it is possible to estimate the color values and volume density values for all points in a specific space in which the object is positioned, thereby generating a 3D model that more accurately reflects the real target object.

An example of the 3D model 520 generated by the method according to an embodiment is illustrated in FIG. 5. As illustrated, the 3D model 520 generated by the method according to an embodiment may more precisely and accurately reflect the shape or texture of the real target object. Accordingly, according to the method of the present disclosure, it is possible to generate a high-quality 3D model close to the photorealistic quality.

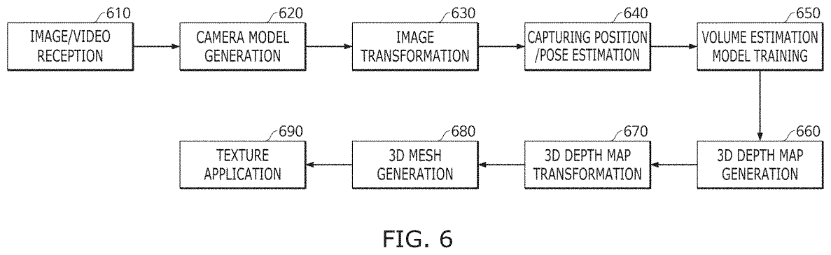

FIG. 6 is a diagram illustrating an example of a method for 3D modeling based on volume estimation in consideration of camera distortion according to an embodiment.

According to an embodiment, the information processing system may perform a 3D modeling method in consideration of camera distortion. Referring to FIG. 6, the process added or changed according to the consideration of camera distortion will be mainly described, and those overlapping with the processes already described above in FIG. 3 will be briefly described.

The information processing system may receive a plurality of images obtained by capturing an image of a target object positioned in a specific space from different directions, or receive an image obtained by capturing an image of the target object from various directions, at 610. Then, the information processing system may estimate a camera model based on the plurality of images, at 620. For example, photogrammetry may be used to estimate a camera model that captured a plurality of images. Then, the information processing system may use the estimated camera model to transform the plurality of images into undistorted images, at 630.

Then, the information processing system may estimate a position and pose at which each image is captured, at 640. For example, the information processing system may estimate a position and pose at which each image is captured, based on the plurality of transformed undistorted images. As another example, the information processing system may estimate the position and pose at which each image is captured based on a plurality of received images (distorted images), and, by using the camera model, correct and transform the estimated position and pose. Then, the information processing system may train the volume estimation model based on the plurality of transformed undistorted images, at 650.

Then, the information processing system may use the volume estimation model trained based on the undistorted image to generate a 3D model of the target object. For example, the information processing system may generate a 3D depth map of the target object, at 660, and, by using the camera model, transform the 3D depth map back to the 3D depth map for the original (distorted) image, at 670. Then, it may generate a 3D mesh of the target object based on the transformed 3D depth map, at 680, and apply the texture information on the 3D mesh to generate a 3D model of the target object, at 690. In this way, in the process of generating a 3D depth map, the process of transforming the image into undistorted image is performed, so that it is possible to generate a precise and accurate 3D depth map, and in the process of generating a 3D model based on the 3D depth map, the process of inversely transforming the 3D depth map is performed, so that it is possible to implement a realistic 3D model that makes the user viewing a 3D model through a user terminal feel as if he or she is capturing a real object with a camera (a camera with distortion).

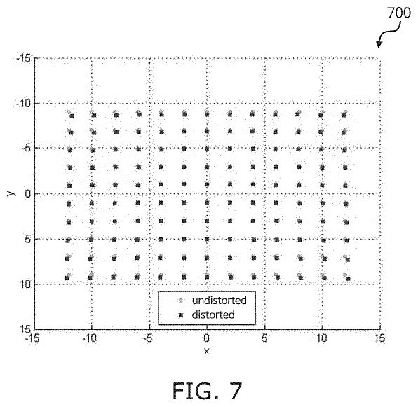

FIG. 7 is a diagram illustrating an example of comparing a distorted image and an undistorted image according to an embodiment. In a dot graph 700 illustrated in FIG. 7, circle-shaped points are coordinates taken by dividing the horizontal and vertical lines of the undistorted image at regular intervals, and square-shaped points are coordinates indicating the position where the portion corresponding to the circle-shaped points in the undistorted image appears in the distorted image. Referring to the dot graph 700, it can be seen that the positions displayed in the undistorted image and in the distorted image are different from each other with respect to the same portion, and in particular, it can be seen that the position difference increases toward the edge of the image. That is, it can be seen that the distortion is more severe toward the edge of the image.

Meanwhile, at least some processes of the 3D modeling method may be performed under the assumption that there is no distortion in the image (pinhole camera assumption). For example, some steps, such as the steps of estimating the position or pose of the camera based on the image, drawing a ray passing through a specific pixel on the image plane from the focal center of the camera, estimating the color and density values of the plurality of points on the corresponding ray to estimate the color value of a specific pixel, and the like, may be performed under the assumption that there is no distortion in the image. In general, most commercially available cameras have distortion, and accordingly, when a 3D modeling method is performed using distorted image, a difference from a real object may occur in a detailed portion.

Accordingly, the 3D modeling method according to some embodiments of the present disclosure may adopt the method of estimating a camera model from an image, and, by using the estimated camera model, transform the image into an undistorted image, thereby generating a 3D model that accurately reflects even the smallest details of the real object.

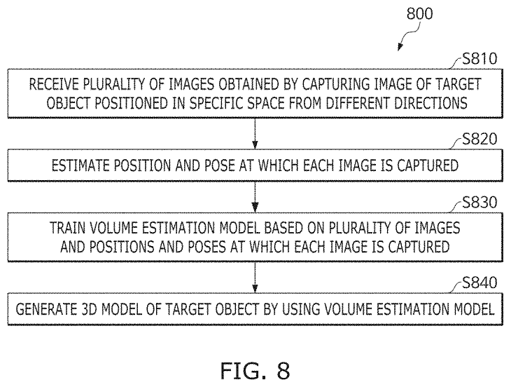

FIG. 8 is a flowchart illustrating an example of a method 800 for 3D modeling based on volume estimation according to an embodiment. It should be noted in advance that the flowchart of FIG. 8 and the description to be described below with reference to FIG. 8 are merely exemplary, and other embodiments may be implemented with various modifications. The method 800 for 3D modeling based on volume estimation may be performed by one or more processors of the information processing system or user terminal.

According to an embodiment, the method 800 may be initiated by the processor receiving a plurality of images obtained by capturing an image of a target object positioned in a specific space from different directions, at 5810. For example, the processor (e.g., one or more processors of the information processing system) may receive from the user terminal an image captured while rotating around the target object, and acquire a plurality of images from the image.

Then, the processor may estimate the position and pose at which each image is captured, at 5820. In this case, the “position and pose at which each image is captured” may refer to the position and direction of the camera at the time point of capturing each image. In order to estimate the position and pose, various estimation methods for estimating the position and pose from the image may be used. For example, a photogrammetry technique of extracting feature points from a plurality of images and use the extracted feature points to estimate the position and pose at which each image is captured may be used, but embodiments are not limited thereto, and various methods for estimating a position and pose may be used.

Then, the processor may train the volume estimation model based on the plurality of images and the position and pose at which each image is captured, at 5830. According to an embodiment, the volume estimation model may be a model trained to receive position information and viewing direction information in a specific space and output color values and volume density values. Further, in an embodiment, the volume estimation model may be trained to minimize a difference between a pixel value included in a plurality of images and an estimated pixel value calculated based on the color value and volume density value estimated by the volume estimation model.

Then, the processor may use the volume estimation model to generate a 3D model of the target object, at 5840. For example, the processor may use the volume estimation model to generate a 3D depth map of the target object, generate a 3D mesh of the target object based on the generated 3D depth map, and then apply texture information on the 3D mesh to generate a 3D model of the target object. According to an embodiment, the 3D depth map of the target object may be generated based on the volume density values at a plurality of points in the specific space inferred by the volume estimation model. In addition, according to an embodiment, the texture information may be determined based on the color values at a plurality of points and plurality of viewing directions in the specific space inferred by the volume estimation model.

Additionally or alternatively, the processor may estimate a camera model, use the estimated camera model to transform the distorted image into undistorted image, and then perform the process described above. For example, the processor may estimate the camera model based on the plurality of images, use the estimated camera model to transform the plurality of images into a plurality of undistorted images, and train the volume estimation model by using the transformed plurality of undistorted images. In this case, the estimated position and pose at which each image is captured may be transformed using the camera model, or the position and pose at which each image is captured may be estimated using the undistorted image. Then, the processor may generate a 3D depth map of the target object by using the volume estimation model trained based on the undistorted image, and, by using the camera model, transform the 3D depth map back to the 3D depth map for the distorted image. Then, it may generate a 3D mesh of the target object based on the transformed 3D depth map, and apply the texture information on the 3D mesh to generate a 3D model of the target object.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. In addition, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the embodiments described above have been described as utilizing aspects of the currently disclosed subject matter in one or more standalone computer systems, the present disclosure is not limited thereto, and may be implemented in conjunction with any computing environment, such as a network or distributed computing environment.

Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some embodiments herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for 3D modeling based on volume estimation, the method executed by one or more processors and comprising:
receiving a plurality of images obtained by capturing an image of a target object positioned in a specific space from different directions;
estimating a position and pose at which each image is captured;
training a volume estimation model based on the plurality of images and the position and pose at which each image is captured; and
generating a 3D model of the target object by using the volume estimation model.

2. The method according to claim 1, wherein the volume estimation model is a model trained to receive position information and viewing direction information on the specific space and output color values and volume density values.

3. The method according to claim 2, wherein the volume estimation model is trained to minimize a difference between pixel values included in the plurality of images and estimated pixel values calculated based on the color values and volume density values estimated by the volume estimation model.

4. The method according to claim 1, wherein the generating the 3D model of the target object includes:
generating a 3D depth map of the target object by using the volume estimation model;
generating a 3D mesh of the target object based on the generated 3D depth map; and
applying texture information on the 3D mesh to generate the 3D model of the target object.

5. The method according to claim 4, wherein the 3D depth map of the target object is generated based on volume density values at a plurality of points on the specific space inferred by the volume estimation model.

6. The method according to claim 4, wherein the texture information is determined based on color values at a plurality of points and plurality of viewing directions on the specific space inferred by the volume estimation model.

7. The method according to claim 1, further comprising:
estimating a camera model based on the plurality of images; and
transforming the plurality of images into a plurality of undistorted images by using the estimated camera model, wherein the volume estimation model is trained based on the plurality of undistorted images.

8. The method according to claim 7, wherein the generating the 3D model of the target object includes:
generating a 3D depth map of the target object by using the volume estimation model;
transforming the 3D depth map by using the camera model;
generating a 3D mesh of the target object based on the transformed 3D depth map; and
applying texture information on the 3D mesh to generate the 3D model of the target object.

9. A non-transitory computer-readable recording medium storing instructions for execution by one or more processors that, when executed by the one or more processors, cause the one or more processors to perform the method according to claim 1.

10. An information processing system comprising:
a communication module;
a memory; and
one or more processors connected to the memory and configured to execute one or more computer-readable programs included in the memory, wherein the one or more computer-readable programs further include instructions for:
receiving a plurality of images obtained by capturing an image of a target object positioned in a specific space from different directions;
estimating a position and pose at which each image is captured;
training a volume estimation model based on the plurality of images and the position and pose at which each image is captured; and
generating a 3D model of the target object by using the volume estimation model.
